(19) United States
(12) Patent Application Publication
(10) Pub. No.: US 2013/0195543 A1
(43) Pub. Date: Aug. 1, 2013

(54) Frame

(71) Applicant: Liebherr-Hausgerate Lienz GmbH, Lienz (AT)

(72) Inventors: Mohd Kamal MAHAT, Kluang (MY); Lip Keong KWAK, Klang (MY); Muhd Shuhail HASSAN, Kluang (MY); M. Noorashidi M. NASIR, Kluang (MY)

(73) Assignee: Liebherr-Hausgerate Lienz GmbH, Lienz (AT)

(21) Appl. No.: 13/748,018

(22) Filed: Jan. 23, 2013

(30) Foreign Application Priority Data
Jan. 25, 2012 (DE) 102012001321.3

(51) Int. Cl. F16B 12/06

(52) U.S. Cl. CPC F16B 12/06
USPC 403/267; 29/890.035

(57) ABSTRACT

The present invention relates to a frame for a refrigerator and/or freezer or of a refrigerator and/or freezer, wherein the frame consists of several frame parts, wherein one of two frame parts adjacent to each other in the frame has a protrusion and the other one has a receptacle into which the protrusion is inserted, and wherein said two frame parts are connected with each other by the method of ultrasonic welding.

The present invention relates to a frame for and of a refrigerator and/or freezer.

From the prior art, refrigerators and/or freezers in the form of chests are known, which are designed with a frame which serves for fixing glass or plastic panes, in general, these frames are designed to be shiftable relative to a stationarily arranged guideway, in order to provide for access to the refrigerated and frozen goods.

Furthermore, cupboard-like refrigerators and/or freezers are known from the prior art, which include a door extending about a vertical axis. It is known to design this door with a frame and provide a pane surrounded by the frame, e.g. made of glass or plastics, so that the user can look into the interior space of the appliance with the door dosed.

Known frames are manufactured in that the individual frame parts are joined and then held against each other for example by a latching connection. This procedure involves the disadvantage that the frame possibly has no sufficient stability so that deformations of the frame may occur, and that between the adjacent frame parts gaps possibly may be formed or be left. These gaps disturb the optical appearance and are susceptible to the accumulation of dirt.

Thus, it is the object underlying the present invention to develop a frame as mentioned above to the effect that the frame has an increased stability as compared to known frames and the above-mentioned problem of the formation of gaps can be prevented.

This object is solved by a frame with the features of claim 1, Accordingly, it is provided that the frame consists of several frame parts, wherein one of two frame parts adjacent to each other in the frame has a protrusion and the other one has a receptacle into which the protrusion is inserted, and wherein said two frame parts are connected with each other by the method of ultrasonic welding.

In ultrasonic welding, the vibrations generated by a generator are transmitted to the components to be connected, whereby the same are heated and preferably melt in their connecting region, whereby a firm connection is achieved between the parts.

By this joining technique, there is provided a stable connection between the frame parts and thus a stable frame as a whole. Apart from this, it can be achieved by the joining technique that the frame parts have no backlash relative to each other and rest against each other completely or largely without leaving a gap. The soiling tendency thereby is reduced and the optical appearance is improved.

The connection of two adjacent frame parts is effected such that for example according to a key-lock principle said protrusion first is introduced into said receptacle and the frame parts then are connected with each other in this position by ultrasonic welding.

In a further aspect of the invention it is provided that the two adjacent frame parts are attached to each other by a positive connection, with the positive connection preferably being a latching connection, wherein a first latching means is arranged at the protrusion or at another point of the frame part, and a second latching means in engagement with the same is arranged at the receptacle or at some other point of the frame part. Thus, it is conceivable to initially latch the two frame parts with each other and then firmly connect the same with each other by ultrasonic welding.

A latching connection can be formed such that when snapping Into place a clicking sound or the like is generated, which is perceptible by a person, so that the person knows that the latching connection does exist. Then, the two frame parts connected in this way can be connected with each other by the technique of ultrasonic welding.

In a preferred aspect of the invention, the above explanations not only apply for two frame parts, but preferably for all frame parts which form the frame.

In a preferred aspect it is provided that the frame is a circumferential, closed frame. In the region surrounded by the frame, one or more glass or plastic panes for example can be located.

The first latching means can be formed such that it protrudes from said protrusion and/or that the second latching means can be formed by a recess. The first latching means thus can be a latching nose which protrudes from said protrusion for example upwards, downwards, or in both directions. This latching nose then can cooperate with a second latching means such that the two frame parts are fixed at each other by positive connection. The second latching means for example can be a recess into which the latching nose or the like engages in the joined condition.

It is conceivable that in a side view of the frame or in a cross-sectional view the first latching means protrudes upwards from the protrusion and engages into the recess from below, which represents the second latching means.

Furthermore, it can be provided that guideways or the like are provided, which ensure an exact introduction of the protrusion into the receptacle, so that in the joined condition of the frame parts protrusion and receptacle assume a certain position relative to each other.

Furthermore, it can be provided that the protrusion is formed as tab whose width and length is greater than its thickness. From the one frame part, one or more tabs or other protrusions can extend in one or both end regions thereof, which on joining with an adjacent frame part is/are introduced into a receptacle of the adjacent frame part.

In a further aspect of the invention it is provided that the ultrasonic welding connection exists between the protrusion and one or more elements, in particular walls, adjoining the recess. The recess includes one or more walls defining the same or other elements arranged in the region of the recess. It is advantageous when these walls or elements or partial regions thereof are connected with regions of the protrusion of the frame part by ultrasonic welding. As set forth above, not only a stable and reliable connection of the frame parts can be achieved in this way, but furthermore the advantage can be achieved that when putting the frame parts together, the same rest against each other without leaving a gap and also stay in this position.

In an advantageous aspect of the invention it is provided that the frame surrounds at least one pane, in particular at least one glass or plastic pane and in particular encloses the same in its edge region. It is conceivable that the at least one pane is received in one or more receptacles of the frame parts, so that the pane or panes is/are not shiftable relative to the frame or only by applying force.

In principle, the invention also comprises the case that the at least one pane is movable, for example shiftable or pivotable, relative to said frame.

The frame of the present invention preferably is a part of a closure element of the refrigerator and/or freezer, by means of which the cooled interior space of the appliance can be closed. This closure element for example can be formed as sliding cover, as pivotable cover or also as door which is pivotable about a vertical axis.

In principle, the invention alternatively or additionally also comprises the case that the frame is a stationarily arranged part. It is conceivable, for example, that the frame forms the upper or front end of the body of a chest refrigerator and/or freezer or of an upright refrigerator and/or freezer, and that the closure element, such as e.g. a cover, a flap or a door or drawer etc. is arranged relative to this stationary frame. This frame can include e.g. stationarily arranged guideways for a sliding cover.

The present invention furthermore relates to a closure element according to claim 8 and to a refrigerator and/or freezer which includes at least one frame according to any of claims 1 to 7. The appliance for example can be a chest refrigerator and/or freezer or also an upright refrigerator and/or freezer.

In the case of a chest it can be provided that the frame is part of a sliding cover or of a pivotable flap, by means of which the cooled compartment can be closed. The frame can be designed to extend all around and surround one or more panes etc. The frame also can be connected with the upper end region of the body of the appliance or form the upper end region of the body, with the frame being arranged stationarily.

In the case of an upright refrigerator and/or freezer if can be provided that the frame forms that part of a door which closes the Interior space of the appliance. The frame preferably is formed all around. In the region surrounded by the frame a glass or plastic pane can be located, which provides for looking into the appliance interior, even if the door is closed.

The present invention finally relates to a method for manufacturing a frame for a refrigerator and/or freezer, in particular a frame according to any of claims 1 to 7, comprising the following steps: joining two frame parts and connecting the joined frame parts by ultrasonic welding. It can be provided that the step of joining the frame parts is effected such that the frame parts preferably are audibly latched with each other and subsequently a permanent connection is achieved by the method of ultrasonic welding.

As explained, it is conceivable that a latching connection is made when Joining the two frame parts, wherein it preferably is provided that this latching connection is made between the protrusion of the one frame part and the receptacle of the other latching element, in principle, this latching connection also can be made between other parts or regions of the frame parts.

Further details and advantages of the invention will be explained in detail with reference to an exemplary embodiment described in detail in the drawing, in which:

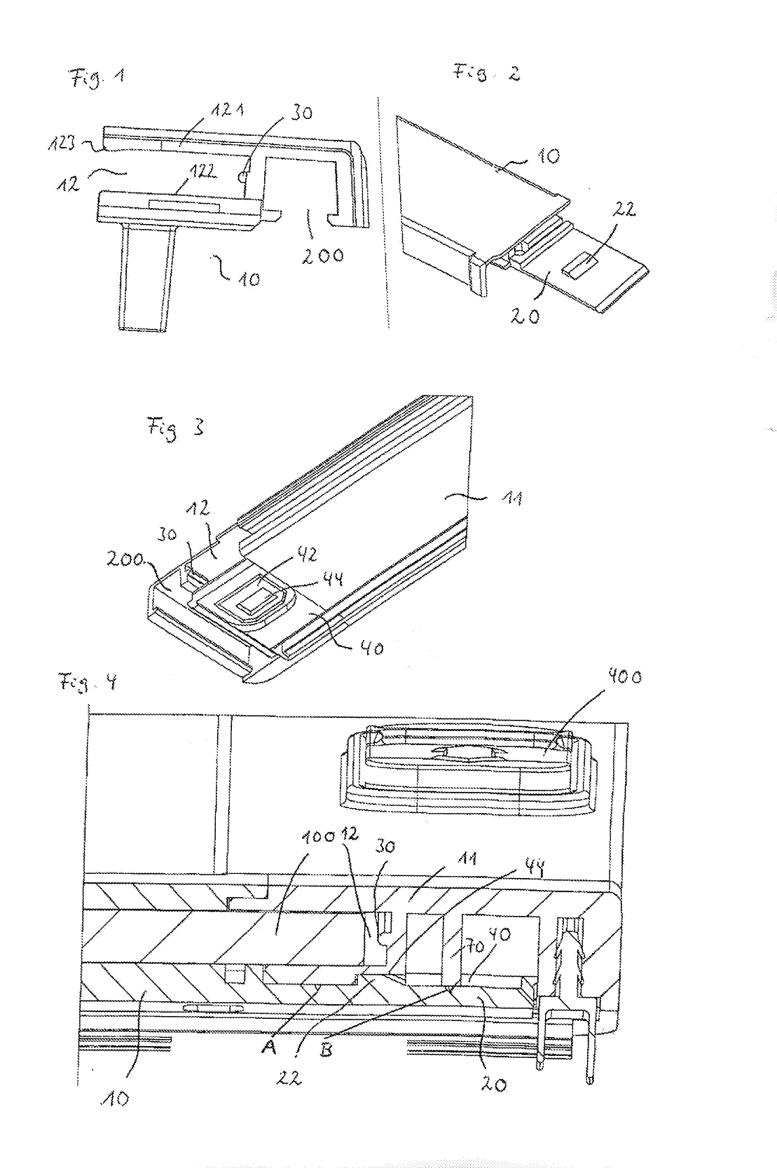

FIG. 1; shows a sectional view through a frame part of a frame according to the invention,

FIG. 2; shows a perspective view of the end region of a frame part with protrusion,

FIG. 3: shows a perspective view of the end region of a frame part with receptacle for the protrusion, and

FIG. 4: shows a sectional view through two frame parts connected with each other in the corner region of the frame.

With reference numeral 10, FIG. 1 designates a frame part of a frame of the present invention.

In principle, the frame or its frame parts can be made of plastics or also of metal, such as e.g. aluminum.

The frame part 10 includes an open groove 12 facing the interior of the finished frame, into which the edge region of a glass plate 100 is inserted, which is shown in FIG. 4. The glass plate 100 is inserted or accommodated between the opposed walls 121 and 122, wherein one or both of the walls have a protrusion 123 directed to the other wall, which exerts a compressive force on the glass plate 100, in order to hold the same in the groove 12 and stationarily fix it therein.

A particularly reliable fixation of the glass plate 100 is obtained in that the frame parts have no backlash relative to each other, since two adjacent frame parts each are connected with each other by the method of ultrasonic welding.

In principle, it is also conceivable that the glass plate 100 is shiftably or firmly held in the groove. A preferred embodiment, however, consists in that the glass plate 100 or some other pane is stationarily arranged relative to the frame.

Preferably, the groove 12 is arranged all around or at least on two opposite sides of the frame.

Reference numeral 30 designates a protrusion extending from the groove base, which faces the edge region of the glass plate 100 and forms a stop for the glass plate 100.

In FIG. 1, reference numeral 200 designates a groove of the frame part which for example serves for receiving a sealing element and/or which runs on or in a guideway of the body (not shown) of the appliance.

FIG. 2 shows the end region of a first frame part 10, which includes a protrusion 20 from whose upper surface the latching nose 22 extends.

FIG. 3 shows the end or corner region of a second frame part 11 which includes a receptacle 40 which is dimensioned such that in this receptacle 40 the protrusion 20 can be accommodated.

As can be taken from FIG. 3, a depression or recess 44 is provided in the region of the receptacle 40 or a wail 42 of the receptacle, into which the latching nose 22 of the protrusion 20 engages when both frame parts 10, 11 are connected with each other. As soon as this is the case, a click or some other sound will be generated by snapping into place, whereby it is signalized that the latching connection is established.

FIG. 3 furthermore shows that the receptacle 40 is arranged such that the first frame part 10 is arranged at right angles to the second frame part 11, so that in the completely mounted frame the frame parts 10, 11 shown in FIGS. 2 and 3 not only form two straight sides, but also a corner region.

Preferably, it is provided that the frame is formed by four frame parts 10, 11, two of which form the lateral regions of the frame and the two other frame parts are arranged between the same, so that in general a closed formation is obtained. The two other frame parts thus can form the front and back side of the frame, wherein it preferably is provided that the front-side frame includes a handle 400 (cf. FIG. 4) or the like.

It is conceivable that the frame includes two frame parts 10 shown in FIG. 2 as well as two frame parts 11 shown in FIG. 3, wherein the frame parts 10, 11 each include the connecting elements shown at their two end regions, i.e. the protrusion 20 on the one hand and the receptacle 40 on the other hand. It is also conceivable to form the frame parts 10, 11 such that the same have a protrusion 20 in their one end region and a receptacle 40 in the other end region.

After establishing the positive connection between two frame parts 10, 11, the same are fixed relative to each other by the method of ultrasonic welding The connection thereby is stabilized or becomes inseparable, which is due to the fact that the regions to be connected are molten or partly molten, whereby an intimate connection is established in the connecting region.

FIG. 4 shows the preferred fine-shaped regions A and B of the input of energy by ultrasonic welding.

The region A is located between the base surface of the protrusion 20 of the frame part 10 and the adjoining wall 44 of the receptacle 40 and the region B is located between a further portion of the base surface of the protrusion 20 and the end face of a web 70 of the other frame part 11 extending into the recess.

In this way, a firm and loadable connection is obtained between the protrusion 20 and the wall 44 of the receptacle 40 or webs 70 or the like of the frame part 11 including the receptacle 40, which protrude into the region of the receptacle 40.

FIG. 4 illustrates that the fine-shaped regions A and B are arranged on both sides of the latching nose 22. The latching nose 22 is beveled at its insertion end shown on the right, in order to simplify the joining operation, but includes a steeply or vertically extending latching edge, which effects the positive connection. The latching nose 22 is located in the recess 44 and in this way fixes the two frame parts 10, 11 relative to each other by positive connection.

Manufacturing the frame according to the invention turns out to be comparatively easy, since the four frame parts forming the frame are put together after inserting the glass pane or some other pane and then are connected with each other by ultrasonic welding.

As explained above, the frame according to the invention preferably forms part of a sliding cover of a chest refrigerator and/or freezer and in a preferred aspect of the invention surrounds one or more transparent panes, which permit a look into the cooled space with the sliding cover closed. In this case, the frame can run on guideways arranged laterally in shifting direction, which are arranged on or in the body of the appliance.

Preferably, the appliance includes a plurality of such closure elements, which run on guideways arranged one above the other at the body and hence-both are shiftable.

1. A refrigerator and/or freezer frame comprising several frame parts, wherein one of two frame parts adjacent to each oilier in the frame has a protrusion and the other one has a receptacle into which the protrusion is inserted, and wherein said two frame parts are connected with each other by an ultrasonic weld.

2. The frame according to claim 1, wherein the two adjacent frame parts are attached to each other by a positive connection, with the positive connection preferably being a latching connection, wherein a first latching means is arranged at the protrusion or at another point of the frame part, and a second latching means in engagement with the same is arranged at the receptacle.

3. The frame according to claim 2, wherein the first latching means is formed such that it protrudes from said protrusion and/or that the second latching means is formed by a recess.

4. The frame according to claim 2, wherein in a side view of the frame the first latching means protrudes upwards from the protrusion and engages into the recess from below, which forms the second latching means.

5. The frame according to claim 1, wherein the protrusion is formed as tab whose width and length is greater than its thickness.

6. The frame according to claim 1, wherein the ultrasonic welding connection, exists between the protrusion and one or more elements, in particular wails, adjoining the recess.

7. The frame according to claim 1, wherein the frame surrounds at least one pane, in particular at least one glass or plastic pane and in particular encloses the same in its edge region and/or that the frame forms part of a closure means, in particular of a door or a cover of the refrigerator and/or freezer.

8. A closure element of a refrigerator and/or freezer, in particular a flap, sliding cover, door or drawer, wherein the closure element includes at least one frame according to claim 1.

9. A refrigerator and/or freezer, comprising a frame according to claim 1, wherein the refrigerator and/or freezer is a chest refrigerator and/or freezer whose body and/or whose closure element, in particular whose sliding cover, includes such a frame.

10. The refrigerator and/or freezer according to claim 9, wherein the frame surrounds at least one pane, in particular at least one glass or plastic pane and in particular encloses the same in its edge region.

11. A method for manufacturing a frame for a refrigerator and/or freezer, according to claim 1, comprising the following steps: joining two frame parts and connecting the joined frame parts by ultrasonic welding.

12. The method according to claim 11, wherein a latching connection is made when joining the two frame parts, wherein the latching connection is made between the protrusion of the one frame part and the receptacle of the other frame part.
